(19) United States
(12) Patent Application Publication
(10) Pub. No.: US 2006/0164913 A1
(43) Pub. Date: Jul. 27, 2006

(54) Multi-chamber integrated mixing and delivery system

(75) Inventor: Yves P. Arramon, Sunnyvale, CA (US)

Correspondence Address: ARTHROCARE CORPORATION, 680 VAQUEROS AVENUE, SUNNYVALE, CA, 94085-3523, US

(73) Assignee: ArthroCare Corporation, Sunnyvale, CA (US)

(21) Appl. No.: 11/041,146

(22) Filed: Jan. 21, 2005

(51) Int. Cl. B01F 13/06

(52) U.S. Cl. 366/139

(57) ABSTRACT

Systems and methods are provided for the mixing of materials to form a homogenous mixture and for delivering the mixture to a target site. In one embodiment a vial containing a liquid monomer is detachably engaged with a mixing chamber. The liquid monomer flows into the mixing chamber and combines with a powder to form a flowable composition such as bone cement. The bone cement may then be injected from the device to a target location.

### FIELD OF THE INVENTION

The present invention relates to devices and systems for the sealed mixing of two or more materials and the subsequent delivery of the combined material to a target location. Such devices and systems are particularly useful for the mixing of bone cement and other toxic or noxious materials in a sealed environment and the subsequent delivery or injection of the material to a target site within the body, also performed in a sealed environment.

### BACKGROUND OF THE INVENTION

The introduction of viscous materials to an implantation site within a patient to affect one or more therapeutic goals is well known. Material ranging from typical fluids or solutions to non-Newtonian fluids, pastes, gels and the like has been used for one purpose or another in the medical arts.

A commonly injectable viscous material is bone cement. Bone cement is often used to affix a prosthesis to a bone or joint structure. Hip and knee joints are the most common examples of such prosthetic devices. Another common use of bone cement is for repairing or mending bone fractures or shattered bone or for supplementing a weakened bone structure, such as in the case of vertebroplasty. Bone cement may also be used for cosmetic or dental surgery. Moreover, bone cement may be used as a drug delivery or release system, whereby the bone cement is mixed with antibiotics or other desired drugs and applied to a specific surgical site such that the drugs leach out and are delivered directly to the surgical site.

Bone cements are typically formed by mixing a polymer powder or beads and a liquid monomer. Examples of bone cements include polymethyl methacrylate (PMMA), methyl methacrylate. Examples of other types of non-polymer based bone cements include calcium phosphate cements and calcium sulphate cements. In order to provide bone cement having the desired properties, the separately packaged compounds, must be uniformly and thoroughly mixed so that a homogeneous product is produced. Once the components are mixed, there is a limited time within which the blended mixture is effective or usable. Thus, the mixing operation must be conducted immediately prior to use of the cement, and is usually done by a medical professional near the patient in a clinical setting.

Mixing or blending of the compounds may be accomplished by any means that applies large strains to the mixtures mass at a relatively slow rate to produce a uniform, homogenous distribution of the components within the mixture. The mixing procedure may be performed in an “open” environment, such as in a bowl with the use of a spatula, or in a “closed” environment, such as in vials that can be shaken or in other vessels that contain a self-contained stirring mechanism. The fully mixed cement is then transferred to a separate dispensing or injection apparatus. Examples of injection devices are disclosed in U.S. Pat. No. 6,783,515 and U.S. Patent Application Publication Nos. 2003/0018339, 2003/0036762, 2003/0067837 and 2003/0040718. With a number of the known mixing techniques, the cement is poured or spooned from the mixing device to the dispensing device. This is disadvantageous as the bone cement emits vapors which may be noxious and toxic.

U.S. Pat. No. 5,435,645 discloses a mixing device having a sealed vial of liquid monomer and a chamber containing the solid (e.g., powder) component. In order to mix the components, the container holding the liquid is broke and a negative pressure (vacuum) is used to draw the liquid from the vial. A drawback of the system is that additional actions, such as agitating the chamber and/or compacting the mixture, are necessary to effectively mix the components. The extra time necessary to sufficiently mix the entire contents and achieve the requisite physical and chemical properties of the cement may result in hardening of the portion of the material prior to the mixing of entire volume of the material.

Even where mixing of the components is accomplished in a closed environment, many systems still require transfer of the mixture from the mixing device to the delivery or injection device which exposes the mixture to air resulting in the likely formation of air bubbles within the cement. These air bubbles may be captured within the flow of the injected cement; compressing as it is pressurized; then, suddenly expanding within the body. This may force the injected material to expel into undesired anatomic sites and introduce air into the blood stream.

Another type of injector and mixing system is described in U.S. Patent Application Publication No. 2003/0012080. Although the disclosed system provides a direct transfer of cement from the mixer to the injector chamber, the surgeon is still exposed to the undesirable fumes arising from the monomer liquid as it is poured into the mixing chamber.

Another injector system is disclosed in copending U.S. patent application entitled HIGH PRESSURE INJECTION SYSTEM FOR DELIVERING THERAPEUTIC AGENTS HAVING FLUID TIGHT CONNECTOR, filed Dec. 17, 2004 (ARTC Docket No. PX-16). The described injector system includes a port or connector assembly to fluidly join an injection chamber and a separate self-contained mixing chamber such that no vapor fumes are released. Both the monomer and the powder components are contained in the mixing chamber or cartridge. Once the components are mixed in the mixing chamber, transfer of the mixed contents into the delivery chamber is carried out through a valve that may be opened and closed. Since this system relies on mixing with agitation it may introduce air into the system as in some of the other devices described in the above referenced patents.

There still exists a need to provide a convenient integrated mixing and injection system in a completely sealed, airtight manner such that the surgeon, patient and other persons are not exposed to any vapors arising from mixing the bone cement.

The system of the present invention includes systems, devices and methods adapted to meet such needs and provides other advantages readily apparent to those with skill in the art.

### SUMMARY OF THE INVENTION

The present invention includes systems and methods for the transfer of material from one chamber or device to another chamber or device in a completely sealed, airtight environment and in an integrated fashion. The invention is particularly suitable where the material is viscous and/or where it is preferential to maintain the material in a sealed environment where fumes from the material are unable to escape into the ambient air and where the ambient air is unable to enter into the sealed environment.

The subject systems are configured to mix and inject a viscous material, where the system includes a sealed chamber for mixing two or more ingredients of the viscous material and from which the mixed viscous material is directly injected to a target site. The systems may be provided fully integrated where a sealed chamber containing one component, such as a vial of liquid, is provided in a sealed engagement with a chamber containing another component, such as a powder component. Mixing the of components is done on demand by the user wherein the sealed engagement between the two chambers is breached, and the materials are allowed to mix, in particular, one of the materials, e.g., the liquid material, is allowed to escape from its chamber and enter into the other chamber. Mixing and commingling of the component to achieve a homogenous mixture is accomplished by virtue of the simple configuration of the integrated chambers and the relative axial movement between the two and does not require the use of, e.g., vacuum pressure, mechanical agitation of the chambers, etc. An optional third integrated chamber or an extension of the second or mixing chamber may be provided for receiving the mixture where the chamber is configured for dispensing or injecting the mixture to a target site. The system is configured such that each of the chambers is sealed from the external environment where the escape of fumes and/or the intake of ambient air is prevented.

The methods of the present invention include a method for preparing a material for injection into the body, where the method specifically includes providing a first sealed chamber containing a first component of the material, providing a second sealed chamber containing a second component of the material where the sealed chambers are sealed engagement with each other, breaching the sealed engagement between the two chambers, transferring the component from the first chamber to the second chamber in a sealed manner and mixing the two components to produce a homogenous mixture of the material. Optionally, the methods may include transferring the homogenous mixture to another integrated chamber configured to dispense the mixture. Certain of the subject methods further include injecting the material to a target site where the homogenous material is dispensed or ejected directly from the second chamber to the target site. All of the above steps are preferably conducted in a sealed or airtight manner whereby the escape of fumes and/or the intake of ambient air is prevented.

One application of the invention is directed to vertebroplasty wherein a system is provided having a sealed vial containing a liquid material and a sealed chamber containing a powder material where the vial and the chamber are in sealed engagement with each other. Mixing of the two ingredients as described above creates a bone cement material which is dispensable directly from the mixing chamber into at least one vertebra in an airtight manner.

These and other objects, advantages, and features of the invention will become apparent to those persons skilled in the art upon reading the details of the invention as more fully described below.

### BRIEF DESCRIPTION OF THE DRAWINGS

The invention is best understood from the following detailed description when read in conjunction with the accompanying drawings. It is emphasized that, according to common practice, the various features of the drawings may not be to-scale, and the dimensions of the various features may be arbitrarily expanded or reduced for clarity. Included in the drawings are the following figures:

FIG. 1 illustrates one embodiment of the present invention in a packaged system in which a sealed vial or ampule of liquid and a sealed chamber of a solid or non-liquid material are provided where the chamber is configured to dispense a material from within the chamber.

FIG. 2 illustrates the system of FIG. 1 in which various locking and sealing components have been removed from the vial and the chamber to allow their coupling and sealed engagement with each other.

FIG. 3 illustrates the vial and chamber in a coupled but sealed engagement with respect to each other and the external environment and the breach of the vial barrier seal.

FIG. 4 illustrates the breaching of the sealed engagement between the vial and the chamber and the subsequent commingling of their contents within the chamber.

FIG. 5 illustrates the mixing of the contents to form a homogenous mixture.

FIG. 6 illustrates the transfer of the homogenous mixture from the mixing chamber of the integrated system to an injection chamber of the system and subsequent locking of the plunger to seal the high pressure injection chamber.

FIG. 7 illustrates engagement and use of a handle mechanism to dispense or eject the homogenous material from the injection chamber.

FIG. 8 illustrates an embodiment of a vial having a dual layer septum which is usable with the present invention.

### DETAILED DESCRIPTION OF THE INVENTION

Before the present invention is described, it is to be understood that this invention is not limited to particular applications and embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

Although any devices, method or materials similar or equivalent to those described herein can be used in the practice or testing of the present invention, the preferred methods and materials are now described. While the present invention is especially in injecting with bone cement, such as PMMA, and the invention is described with reference to such application, such description is not intended to be limiting and may be used with various injectable materials, particularly viscous materials, for various applications.

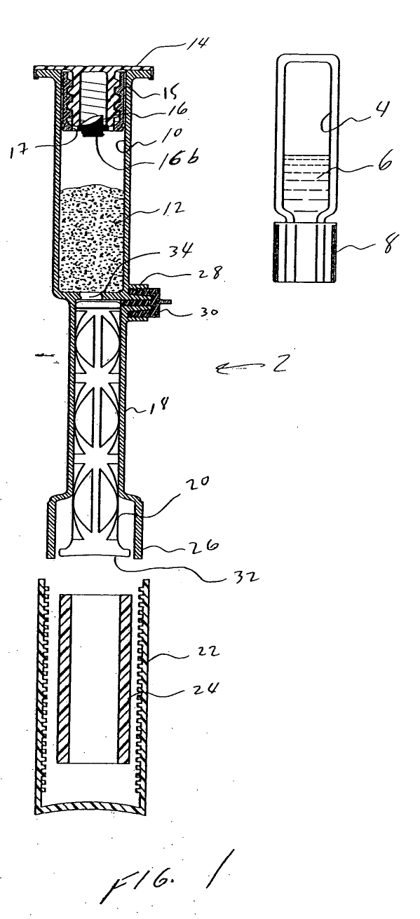

Referring now to the drawings, and to FIG. 1 in particular, there is illustrated a system 2 including a first sealed chamber or vessel 4, such as a vial or ampule, for holding or containing at least one component or compound 6 for forming a mixture of components or compounds. For purposes of providing a liquid monomer component of a bone cement material, vial 4 is preferably cylindrical and made of any material suitable for long term storage of compound 6 such as metal, chemically inert polymers, or glass. These materials may include additional features such as coatings or opacification additives for light shielding as is desired for long term storage and handling of compound 6. Vial 4 is provided with an opening for receiving and dispensing its contents which is sealed prior to use to be airtight by a breakable or breachable septum (not shown). In a preferred embodiment, as illustrated in FIG. 8, the septum 5 includes an inner layer 7 formed over the opening of vial 4 and an outer layer 9 laminated to inner layer 7. In one embodiment, inner layer 7 is made of a metallic foil material, such as annealed steel, or any malleable, vapor impermeable material suitable for this medical application and outer layer 9 is made of a plastic material such as a polymer suitable for enhancing the seal of openings 17. This combination of layers enhances the seal over orifice 17 with bushing 15 as well as provides long term storage of the monomer compound 6 when not in use. Vial 4 is further enclosed by a cap 8 to protect the septum from unintentional breach prior to use. Cap 8 may engage with vial 4 in a threaded, snap-fit or other suitable engagement.

System 2 further includes a second chamber 10 containing at least one second component or compound 12 for forming the mixture. Where the mixture to be formed is bone cement, this second component includes a polymer solid, such as in the form of beads or a powder. As chamber 10, when in use, is to receive vial 4, it has a shape and volume to accommodate vial 4. A first end of chamber 10 has an opening which is also provided sealed by means of a cap 14. Cap 14 has outer threads which engage with the inner threads of a bushing 15 snuggly but slidably received within the distal end of chamber 10. Bushing 15 provides a perforator 16, which may have a raised or sharp configuration for cutting or puncturing septum 5 upon contact. Straddling or encircling perforator 16 is one or more openings 17 into chamber 10. When cap 14 is engaged within the first end of chamber 10, opening(s) 17 is (are) sealed, maintaining the contents of chamber 10 in a sterile environment.

Mixing chamber 10 also has an opening 34 which extends into another chamber 18. The mixing chamber 10 may be sized to hold at least, for example, about 10 cc and generally not less than 1 cc. Opening 34 is configured to sealably engage with a plug 16b of bushing 15 (or perforator 16) which is shown having a threaded feature. Both may have a threaded configuration or may be designed to snap-fit together when the two are approximated with and forced against each other. This breachable barrier configuration allows flow of the liquid monomer into the mixing chamber 10 without the need to break and ampule and without a need for a filter to remove any glass debris.

Chamber 18 is sized and configured for receiving a plunger or piston 20 in a sealed, sliding engagement and is large enough to accommodate the entire volume of mixed material. The plunger may have a diameter of, for example, about 0.5 to 0.75 inches. The proximal end 26 of chamber 18 is flared and has external threads to threadably engage with an internally threaded handle 22. A spacer 24 is provided to reside within handle 22 and abut against the proximal end 32 of plunger 20 and the internal proximal end of handle 22 in order to maintain plunger 20 within chamber 18 when not in use and seal the chamber 10 to maintain the content 12 in a sterile environment. At the distal end of chamber 18 and positioned transversely within the wall of chamber 18 is a side port 28 for dispensing the contents of chamber 18. Port 28 may have a luer configuration to mate with a luer of a cannula (not shown), flexible, needle, or the like for injecting the dispensed contents of chamber 18 into a target site, such as within the core of a vertebra. When not in use, port 28 is sealable by a removable plug 30.

As illustrated in FIG. 1, first chamber or vial 4 may be provided or packaged separately from second chamber 10. However, system 2 may be provided in a fully packaged arrangement where vial 4 is provided engaged with chamber 10 but where both are sealed to maintain the sterility and independence of their respective contents prior to mixing.

Upon use of the illustrated embodiment, as illustrated in FIG. 2, cap 8 is removed from vial 4 and may be discarded. Similarly, cap 14 is removed from chamber 10 and may also be discarded. Handle 22 is removed from chamber 18 thereby freeing spacer 24 which may also be discarded. Handle 22 is set aside within the sterile field for later use.

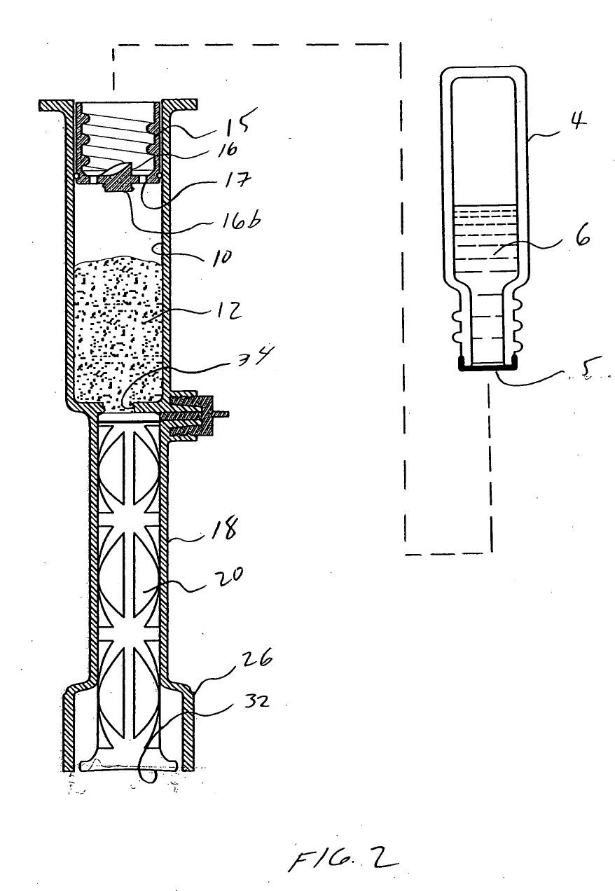

As illustrated in FIG. 3, vial 4 is then rotated or threaded into bushing 15 and advanced axially into chamber 10, as indicated by arrow 36, until the distal end of vial 4 is caused to abut the proximal end of bushing 15. Upon such contact, perforator 16 cuts or punctures septum 5 while the distal edge of the vial seals openings 17 within bushing 15. Vial 4 is then rotated in the opposite direction, as indicated by arrow 38 of FIG. 4, a distance sufficient to unseal openings 17. As the diameter of the vial's opening is relatively large, i.e., does not create a surface tension which prevents gravitational flow of liquid contents, liquid 6 freely empties into chamber 10. Without further action, the fluid 6 and solid 12 components remain substantially unmixed within chamber 10.

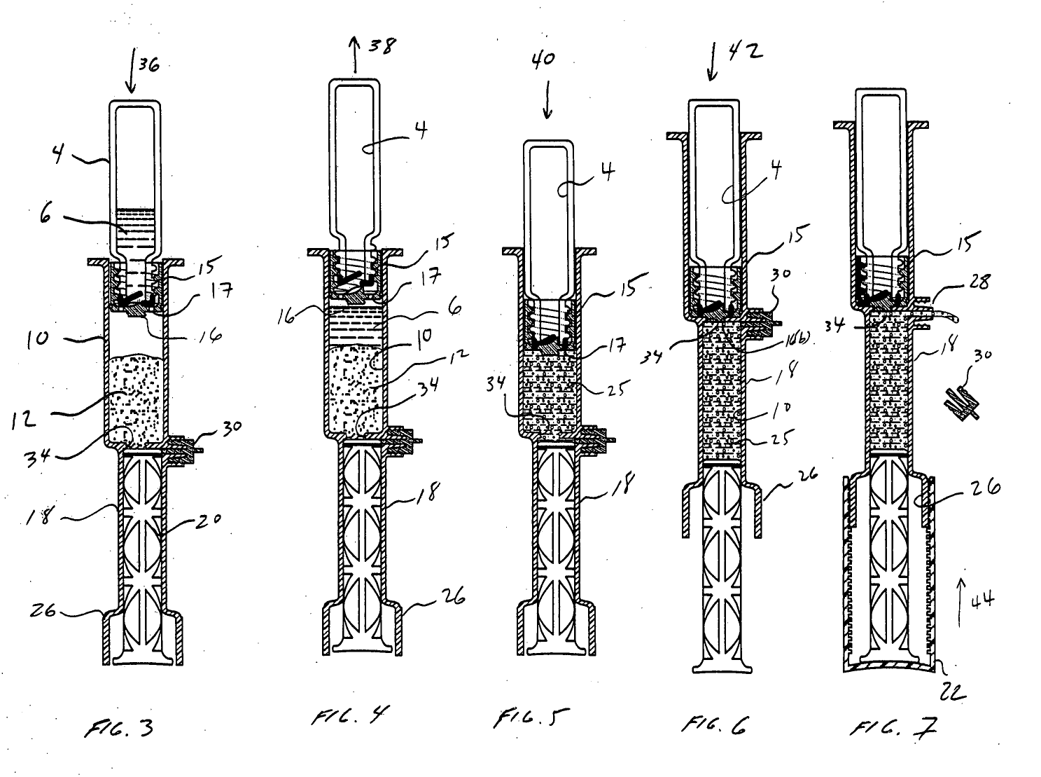

Next, vial 4 is once again rotated and advanced axially into chamber 10, as indicated by arrow 40 of FIG. 5, thereby resealing openings 17. While rotational movement of vial 4 is no longer necessary, a translational force on vial 4 in the direction of arrow 40, now acting as a plunger or piston, further advances it axially into chamber 10 thereby creating a positive pressure within the chamber and causing fluid 6 to diffuse into and wet powder or beads 12. As such, chamber 10 acts as a mixing or blending chamber. Upon fully advancing vial 4 to the extent that it can be advanced into chamber 10, the components 6, and 12 become fully commingled to create a homogenous mixture 25. Thus, the blending or mixing of the components may be accomplished without additional agitation or stirring. However, if desired, the mixture may be gently shaken.

Referring to FIG. 6, after the liquid component is blended into the dry component in the manner described above, and the mixture 25 is liquefied, vial 4 is further advanced and the mixture 25 is forced into the injection chamber 18. The user may at this point choose, at their own discretion, to force the mixture back and forth from chamber 18 to 10 in as many iterations as desired. The mixture is forced completely into chamber 18 and the bushing 15 is locked into place by threading the feature 16 (b) into feature 34 of chamber 10; thereby sealing the mixture 25 into chamber 18.

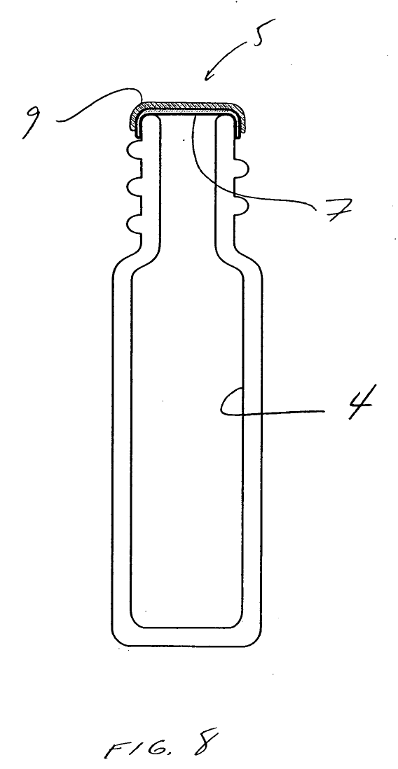

As illustrated in FIG. 7, handle 22 now is threaded back onto proximal end 26 of chamber 18 and plug 30 is removed from port 28. Rotation of handle 22 causes plunger 20 to advance distally in the direction of arrow 44 into chamber 18 which in turn forces mixture to exit or dispense from port 28. As such, chamber 18 acts as an injection or dispensing chamber. A cannula or tube (not shown) may be coupled to port 28 for facilitating the injection of mixture 25 to the target site.

As mentioned above, the systems, devices and material transfer mechanisms of the present invention are particularly useful for the mixing of bone cement, for example, in the context of vertebroplasty applications. As such, the present invention provides a method of performing an orthopedic procedure which includes the mixing or blending of materials, such as a polymer powder and a liquid monomer to form polymethyl methacrylate (PMMA), within a mixing chamber, preferably in a sealed chamber such that no fumes from the material are released into the environment. The method further includes transferring the mixture from the mixing chamber to an injection chamber, also without the release of fumes, and then injecting the material to a target site within the body. Combining the components of the bone cement in accordance with the present invention may be carried out without agitation or stirring which may, in some instances, damage delicate components such as certain visualization particles and introduce air bubbles in the flow of the bone cement.

The present invention may also include those concomitant parts or elements useable with the subject systems and devices in delivering material to a site within a patient. Such elements may include a delivery hose, a cannula (alone or in combination with one or more stylets) and the components of the injectable material, e.g., the bone cement. Together, these elements may form part of a kit or system to be used in a procedure or method as variously described herein. A plurality of such elements and devices may be provided where the devices have the same or varying sizes. The kits may further include instructions for interconnecting the vial to the mixing chamber, performing the necessary steps to mix the ingredients, transfer the implantable material from the mixing chamber to the injection chamber, and injecting the implantable material into a target site within the body.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

That which is claimed is:

1. A system for mixing a homogenous material in an air tight manner, the system comprising:
a first chamber containing a first component of the material; and
a second chamber containing a second component of the material, wherein the second chamber is configured to receive the first chamber in a sealed engagement and further wherein the chambers are respectively configured whereby relative axial movement between the two chambers allows contact between the first and second components and complete mixing of the components to form the homogenous material without any other additional movement of either chamber.

2. The system of claim 1 wherein the first chamber is a vial containing a liquid and the second chamber contains a solid.

3. The system of claim 2 wherein contact between and mixing of the two components occurs within the second chamber.

4. The system of claim 1 wherein the material is a bone cement, the first component is a liquid monomer and the second component is a polymer powder.

5. The system of claim 1 wherein the first chamber comprises an opening sealed by a breachable septum and wherein the second chamber comprises a bushing comprising a protrusion adapted to perforate the breachable septum upon axial movement.

6. The system of claim 1 further comprising a third chamber in fluid engagement with the second chamber and a plunger slidably engagable within the third chamber, wherein axial movement of the first chamber in a first direction causes the homogenous mixture to transfer into the third chamber and seal the fluid engagement with the second chamber.

7. The system of claim 6 wherein the third chamber comprises an exit port wherein axial movement of the plunger in a second direction different than the first direction causes the homogenous material to exit through the port.

8. The system of claim 5 wherein said bushing is adapted to prevent fluid in the second chamber from backflowing into the first chamber when said first chamber is in sealed engagement with the second chamber.

9. A high pressure bone cement injection and mixing system comprising:
a mixing chamber for containing a component of a bone cement to be mixed with a liquid activator, said mixing chamber having a proximal end adapted to sealingly engage with a vial such that the liquid activator from the vial may flow into said mixing chamber without releasing fumes, said mixing chamber further comprising a transfer port at a distal end;
an injection chamber for receiving the bone cement to be injected to a target site, said injection chamber being fluidly engaged with said mixing chamber and comprising an egress port for the bone cement to be ejected; and
a column slidably engaged within said injection chamber, said column having an inserted position for sealing the transfer port during mixing of the bone cement and a retracted position to provide volume for receiving said mixed bone cement.

10. The high pressure bone cement injection and mixing system further comprising a vial having a neck that may sealingly engage with said proximal end of said mixing chamber.

11. A method of preparing a homogenous material in an airtight manner, the method comprising:
providing a first chamber containing a first component of the material;
providing a second chamber containing a second component of the material and configured to receive the material from the first chamber;
engaging the first and second chambers wherein their respective components are sealed from each other; and
transferring the first component to the second chamber to form the homogenous material.

12. The method of claim 11 wherein the first chamber comprises an opening sealed by a breachable septum and wherein the second chamber comprises a protrusion for perforating the breachable septum upon the relative movement between the chambers.

13. The method of 11 further comprising transferring the homogenous material to a third chamber and sealing the third chamber from the first and second chambers.

14. The method of claim 13 further comprising dispensing the homogenous material from the third chamber.

15. The method of claim 11, comprising translating the first chamber with respect to the second chamber to penetrate said first chamber.

16. The method of claim 11 wherein the material is a bone cement, the first component is a liquid monomer and the second component is a polymer powder.

17. The method of claim 15, wherein the relative movement further comprises translating the first chamber in a second axial direction opposite the first axial direction wherein the first component is transferred to the second chamber.

18. The method of claim 17, further comprising connecting a flexible tubing to said third chamber.

19. The method of claim 11 wherein the first chamber is a vial containing a liquid and the second chamber contains a solid.

20. A kit for preparing bone cement from a liquid monomer and a solid polymer, the kit comprising:
the system of claim 1 wherein the first chamber contains the liquid monomer and the second chamber contains the solid polymer; and
instructions for sealably engaging the first chamber with the second chamber and for relatively moving the chambers relative to each other to mix the liquid monomer with the solid polymer within the second chamber.
